(19) United States
(12) Patent Application Publication
(10) Pub. No.: US 2015/0251027 A1
(43) Pub. Date: Sep. 10, 2015

(54) AUTOMATIC CLOSING LOUVER DEVICE FOR FIRE PROTECTION

(71) Applicants: Yoo Sun Ro, Seoul (KR); Young Gon Ro, Seoul (KR); Tae Yoon Noh, Seoul (KR); Byung-Ho Yoo, Inchoen-City (KR)

(72) Inventors: Yoo Sun Ro, Seoul (KR); Young Gon Ro, Seoul (KR); Tae Yoon Noh, Seoul (KR); Byung-Ho Yoo, Inchoen-City (KR)

(21) Appl. No.: 14/196,777

(22) Filed: Mar. 4, 2014

(51) Int. Cl. A62C 2/06; E06B 7/08

(52) U.S. Cl. CPC A62C 2/06; E06B 7/08

(57) ABSTRACT

Disclosed is an automatic closing louver device for fire protection including: a controller having a front surface fixing bar, a rear surface fixing bar, a body open at the lower portion thereof and having a fuse chamber formed at the inside of the lower portion thereof, and an elastic body; plate-like blades each having a blade rotating shaft protrudedly formed on both ends thereof and a lower portion rotatably coupled to the top portion of the body by means of hinge parts; and an outer frame having a front surface plate, a rear surface plate, and two side surface plates, wherein if flames come into contact with the fuse, the fuse is broken and the coupled portion between the rear surface fixing bar and the body moves forwardly by means of the elastic body, so that the blades are rotated and closed to form a fire protection wall.

### BACKGROUND OF THE INVENTION

1. Field of the Invention

The present invention relates to an automatic closing louver device for fire protection, and more particularly, to an automatic closing louver device for fire protection that is installed on windows in an apartment having no balconies or a building having curtain walls to conduct lighting adjustment and further to prevent the flames occurring on a lower floor from moving to an upper floor when a fire breaks out, without using any electric energy.

2. Background of the Related Art

FIGS. 1a to 1c are concept views showing the moving states of flames to an upper floor from a lower floor when a fire breaks out in a multi-floor building.

Windows WD as essential parts in construction are generally provided for lighting and ventilation. In case of a fire breaks out in a multi-floor building, on the other hand, the windows serve as important passages through which the flames F occurring on a lower floor move to an upper floor along the outer wall of the building.

If the building bursts into the flames F, as shown in FIG. 1a, the flames F rise up along the outer wall of the building and break the window WD on the upper floor, so that the flames F are developed to the whole building.

So as to fundamentally avoid the distribution of the flames F, as shown in FIGS. 1b and 1c, a balcony B or a waist-high wall W is installed to prevent the flames F from reaching the window WD on the upper floor. Particularly, the balcony B functions to prevent the flame distribution as well as to block direct sunlight to provide fresh indoor environments, and further, it functions as a refuge area in an emergency state. Accordingly, the balcony B has been generally adopted to all buildings inclusive of existing apartments.

Recently, however, the balcony B exposed to the outside has been closed by means of windows due to the dust and noise generated by air pollution, and accordingly, the balcony B is used as a space like a storage where articles are kept. Further, the balcony B is illegally extended and used as an indoor space.

Due to lots of illegal balcony extension, accordingly, the balcony extension becomes legal on 2006, and after that, it becomes generalized in a number of apartments.

Accordingly, curtain wall type outer walls have been commonly introduced in many high-rise buildings, thus making the balcony B or the waist-high wall W disappear, so that the buildings having curtain walls have enlarged space but become weak in fire and lighting.

In case of the apartment having no balconies or the building having curtain walls, sunlight enters indoors in summer, without any blocking, to raise the indoor temperature, which causes air conditioners having high power consumption to be necessarily operated. Since the quantity of power should be ensured in peak time, the use of the air conditioners in summer where the power consumption is substantially high causes heavy economical losses and serious environmental problems by the generation of a large amount of carbon dioxide. As global warming prevention through energy saving and the reduction of carbon dioxide generation has been issued, recently, effective plans should be proposed so as to decrease the use of air conditioners.

So as to block sunlight, first, the sunlight is basically blocked from the outside by using balconies or sun shields, from the inside by using curtains or blinds, and by using low-emissivity glass (low-E) or a double window having a blind disposed at the inside thereof. Among them, the most effective method for suppressing the increment of the indoor temperature caused by the sunlight basically blocks the sunlight from the outside. Further, the blockage of the sunlight from the outside can be conducted without any obstruction of visional field, unlike the blockage of the sunlight from the inside and by using low-emissivity glass (low-E) or double window which are conducted with the obstruction of visional field.

The easiest method for blocking sunlight from the outside in the apartment having no balconies or the building having curtain walls installs the sun shield. A shelter type sun shield is relatively cheap in price and installed with ease, but has some problems that durability reduction, bad outer appearance, and safety reduction through the influence of horizontal load due to wind in a high-rise apartment. On the other hand, a louver type sun shield has an excellent outer appearance and is few influenced by wind, and therefore, the louver type sun shield is suitable to the high-rise buildings or the buildings having curtain walls. However, the louver type sun shield has a low use rate due to low recognition.

However, conventional louver devices have been applied to buildings designed and constructed after 2008 on which sprinklers and fire glass are compulsorily installed, so that they have no fire protection functions, which makes it hard to be applied to existing buildings.

Generally, the louver device is open in a vertical direction for the purpose of sunlight blocking, without being influenced by wind, and accordingly, if flames in fire move to an upper floor along the outer wall of the building, the louver device does not have any blocking capability, unlike the balcony B.

As shown in FIGS. 2a and 2b, recently, flames move to an upper floor to cause enormous damages because of the non-existence of the balcony B, and especially, high-rise buildings having fifteenth floors or more on which fire cannot be extinguished by using existing water sprinklers may be always under a dangerous situation.

FIGS. 2a and 2b are sectional views showing an automatic closing louver device for fire protection in a conventional practice. The conventional automatic closing louver device is disclosed in Korea Patent Registration No. 10-1096681 issued to the same applicant as this invention.

So as to provide conventional balcony functions, the inventor has developed the automatic closing louver device for fire protection that is capable of blocking sunlight, without being influenced by wind, providing effective lighting, and having a fire protection function of protecting flames in fire from moving to an upper floor.

According to the conventional louver device, blades 200 are erected to block sunlight in a normal state, and they are laid on each other in case of fire so as to prevent flames from moving to an upper floor. In more detail, in a normal state, the blades 200 are in the fixed state by means of stoppers of control pins of a central control plate, and in case of fire, a fuse 330 is broken to allow a blade pusher 362 to push the blade 200 by means of the elastic force of a spring, so that the blade 200 is rotated and closed and at the same time the stopper comes into contact with the blade 200 to enhance the closing state of the blade 200, thus suppressing the rotation of the blade 200, fixing the blade 200, and preventing the blade 200 from being open due to the wind caused by the fire.

In the conventional automatic closing louver device for fire protection, when the fire breaks out, the stoppers of the central control plate are acted as the out of plane load on the center portions of the blades 200 so as to suppress the rotation of the blades, and accordingly, bending moments are generated to make the blades 200 undesirably bent and deformed, thus giving bad influence on the function of the louver device. That is, unfortunately, the blades are limited in length since they have to have sufficient resistance capability (short length or thick section), which causes economical losses.

### SUMMARY OF THE INVENTION

Accordingly, the present invention has been made in view of the above-mentioned problems occurring in the prior art, and it is an object of the present invention to provide an automatic closing louver device for fire protection that can prevent the flames occurring on a lower floor from moving to an upper floor when a fire breaks out in an apartment having no balconies or a building having curtain walls, without using any electric energy.

It is another object of the present invention to provide an automatic closing louver device for fire protection that can effectively adjust lighting according to seasons, thus enhancing heat energy efficiencies and providing fresh indoor environments.

It is yet another object of the present invention to provide an automatic closing louver device for fire protection that can need no maintenance cost because power like electric energy is not required at all, so that the structure is simple, malfunction is few, and no maintenance is needed.

It is still another object of the present invention to provide an automatic closing louver device for fire protection that can be installed on existing buildings, without any separate change in design.

It is yet still another object of the present invention to provide an automatic closing louver device for fire protection that can remove the out of plane load by which the length of each blade is limited occurring in conventional louver devices, thus being applicable to windows in economical and optimal manners.

To accomplish the above-mentioned objects, according to the present invention, there is provided an automatic closing louver device for fire protection installed on an outer wall surface or on the outside of a window, the automatic closing louver device including: a controller having a front surface fixing bar having protrusions formed on both sides of the rear end thereof, a rear surface fixing bar having protrusions formed on both sides of the front end thereof, a body open at the lower portion thereof and having a fuse chamber formed at the inside of the lower portion thereof so as to insertedly mount a fuse thereinto and slots and protrusion coupling portions formed on both side surfaces thereof, and an elastic body adapted to provide a driving force thereto; a plurality of plate-like blades each having a blade rotating shaft protrudedly formed on both ends thereof and a lower portion rotatably coupled to the top portion of the body by means of hinge parts; and an outer frame having a front surface plate having a front surface fixing bar insertion hole formed at the center thereof so as to insert the front end of the front surface fixing bar thereinto, a rear surface plate having a rear surface fixing bar insertion hole formed at the center thereof so as to insert the rear end of the rear surface fixing bar together with the elastic body thereinto, and two side surface plates each having a plurality of blade rotating shaft insertion holes equally spaced apart from each other so as to insert and rotate the blade rotating shafts and attached to both ends of the front surface plate and the rear surface plate on the front and rear ends thereof, wherein the protrusions and the protrusions are coupled correspondingly to the slots and the protrusion coupling portions, and in the state where the protrusions are located at the front ends of the slots and the fuse is located in the fuse chamber between the rear end of the front surface fixing bar and the front end of the rear surface fixing bar, if flames come into contact with the fuse when a fire breaks out, the fuse is broken and the coupled portion between the rear surface fixing bar and the body moves forwardly by means of the elastic body, so that the blades are rotated and closed to form a fire protection wall.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1a to 1c are concept views showing the moving states of flames to an upper floor from a lower floor when a fire breaks out in a multi-floor building;

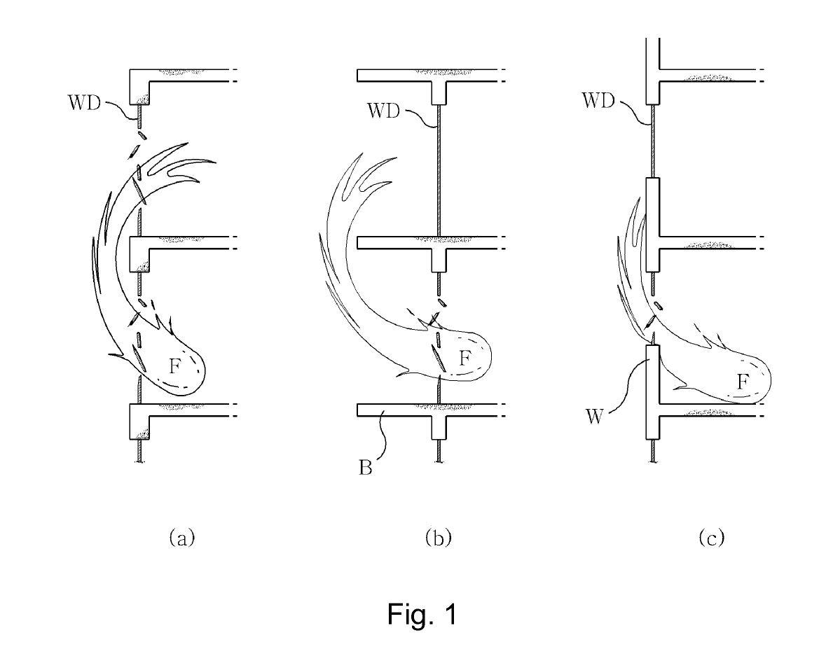

FIGS. 2a and 2b are sectional views showing an automatic closing louver device for fire protection in a conventional practice;

FIG. 3 is a perspective view showing the open state of an automatic closing louver device for fire protection according to the present invention, in a normal state;

FIG. 4 is a perspective view showing the closing state of the automatic closing louver device for fire protection according to the present invention, in a fire breaking state;

FIG. 5 is an exploded perspective view showing the automatic closing louver device for fire protection according to the present invention;

FIG. 6 is a sectional view showing the state where blades are controlled by a controller when the automatic closing louver device for fire protection according to the present invention is open in a normal state;

FIG. 7 is a sectional view showing the state where blades are controlled by a controller when the automatic closing louver device for fire protection according to the present invention is closed in a fire breaking state; and

FIGS. 8a and 8b are concept views showing the state where the moving direction of the flames is controlled in accordance with the opening and closing states of the blades in a multi-floor building wherein the automatic closing louver device for fire protection according to the present invention is installed.

### DETAILED DESCRIPTION OF THE PREFERRED EMBODIMENT

Hereinafter, an explanation on an automatic closing louver device for fire protection according to the present invention will be in detail given with reference to the attached drawing.

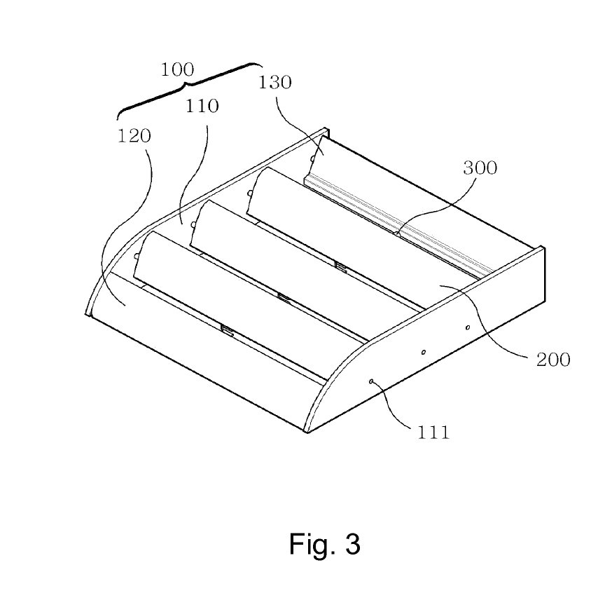

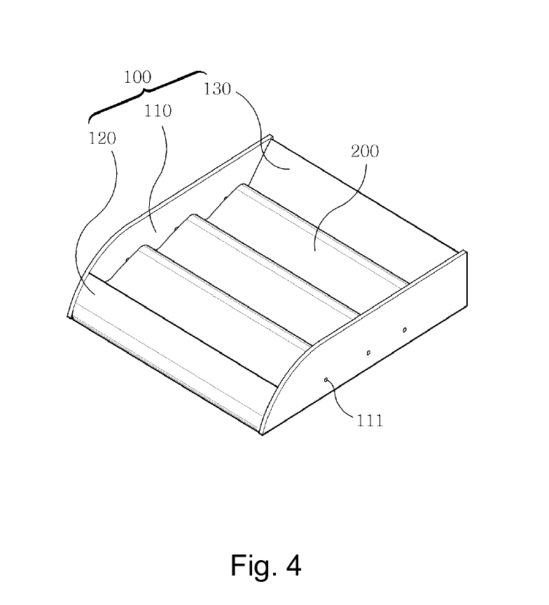

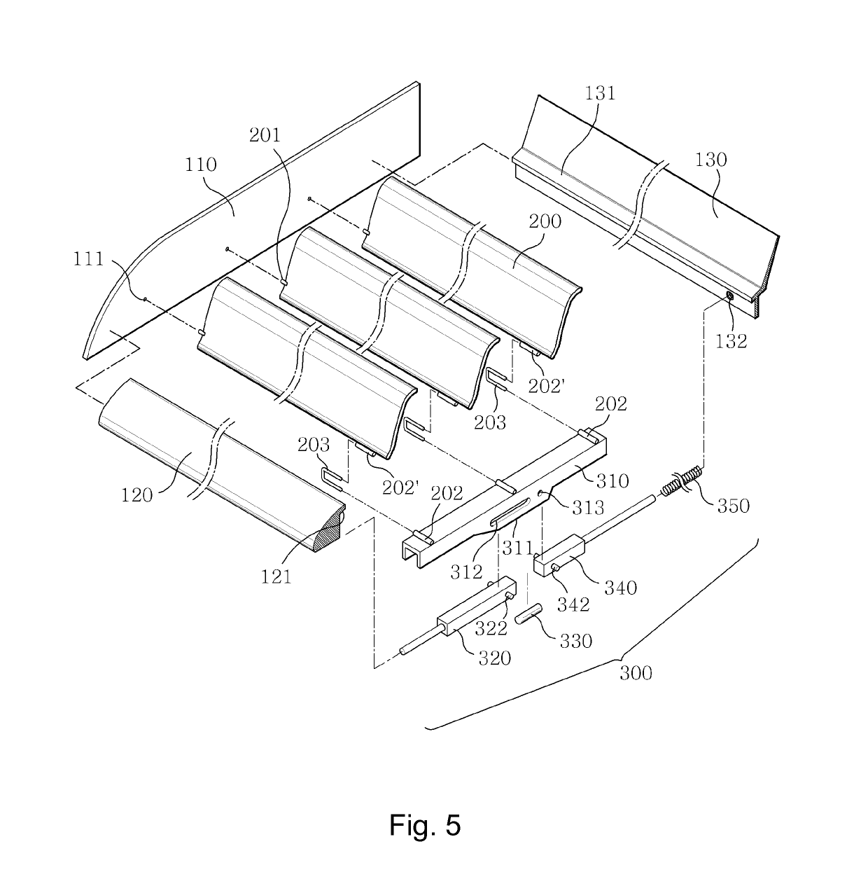

FIG. 3 is a perspective view showing the open state of an automatic closing louver device for fire protection according to the present invention, in a normal state, FIG. 4 is a perspective view showing the closing state of the automatic closing louver device for fire protection according to the present invention, in a fire breaking state, and FIG. 5 is an exploded perspective view showing the automatic closing louver device for fire protection according to the present invention.

According to the present invention, an automatic closing louver device for fire protection installed on an outer wall surface or on the outside of a window WD, the automatic closing louver including: a controller 300 having a front surface fixing bar 320 having protrusions 322 formed on both sides of the rear end thereof, a rear surface fixing bar 340 having protrusions 342 formed on both sides of the front end thereof, a body 310 open at the lower portion thereof and having a fuse chamber 311 formed at the inside of the lower portion thereof so as to insertedly mount a fuse 330 thereinto and slots 312 and protrusion coupling portions 313 formed on both side surfaces thereof, and an elastic body 350 adapted to provide a driving force thereto; a plurality of plate-like blades 200 each having a blade rotating shaft 201 protrudedly formed on both ends thereof and a lower portion 220 rotatably coupled to the top portion of the body 310 by means of hinges 202, 202′ and 203; and an outer frame 100 having a front surface plate 120 having a front surface fixing bar insertion hole 122 formed at the center thereof so as to insert the front end of the front surface fixing bar 320 thereinto, a rear surface plate 130 having a rear surface fixing bar insertion hole 132 formed at the center thereof so as to insert the rear end of the rear surface fixing bar 340 together with the elastic body 350 thereinto, and two side surface plates 110 each having a plurality of blade rotating shaft insertion holes 111 equally spaced apart from each other so as to insert and rotate the blade rotating shafts 201 and attached to both ends of the front surface plate 120 and the rear surface plate 130 on the front and rear ends thereof, wherein the protrusions 322 and the protrusions 342 are coupled correspondingly to the slots 312 and the protrusion coupling portions 313, and in the state where the protrusions 322 are located at the front ends of the slots 312 and the fuse 330 is located in the fuse chamber 330 between the rear end of the front surface fixing bar 320 and the front end of the rear surface fixing bar 340, if flames F come into contact with the fuse 330 when a fire breaks out, the fuse 330 is broken and the coupled portion between the rear surface fixing bar 340 and the body 310 moves forwardly by means of the elastic body 350, so that the blades 200 are rotated and closed to form a fire protection wall.

The automatic closing louver device for fire protection according to the present invention largely includes the controller 300, the blades 200, and the outer frame 100.

The outer frame 100 includes the front surface plate 120, the rear surface plate 130 and the two side surface plates 110.

The outer frame 100 is desirably made of a steel material on which corrosion and fire-resistant paint is coated, when considering the outer appearance, durability, structural stability and fire-resistant performance, and further, the outer frame 100 has such a section size that gives no trouble in the process where the louver device of the present invention works during fire. Furthermore, the outer frame 100 may be punched like ribs on the wings of an airplane, so as to achieve light weight.

The controller 300 largely includes the front surface fixing bar 320, the rear surface fixing bar 340, the body 310 and the elastic body 350, and the elastic body 350 is desirably made of a spring strong against heat since it provides the total driving force of the controller 300 in case of fire.

So as to adjust the lengths of the front surface fixing bar 320 and the rear surface fixing bar 340, a general length adjusting member (not shown) like bolt and nut is attached to the intermediate portion or the end portion of the front surface fixing bar 320 and the rear surface fixing bar 340, and accordingly, the inclined angles of the blades 200 are adjustable to effective lighting angles. Further, if the lengths of the slots 312 or the locations of the protrusions 322 and 342 or the protrusion coupling portions 313 are adjusted, the same effects as those obtained by the adjustment of the lengths of the front surface fixing bar 320 and the rear surface fixing bar 340 can be obtained.

The blades 200 are desirably made of a steel material on which corrosion and fire-resistant paint is applied or coated, in the same manner as the outer frame 100, and so as to enhance the fire-resistant performance, the blades 200 desirably have a material strong against heat like ceramic that is laid on the underside surfaces thereof.

The fuse 330 is inserted into the fuse chamber 311 and becomes broken at a given temperature by means of the flames F. The fuse 330 may be formed of a glass bulb or fusible link used in a sprinkler, which is destructed over a given temperature in case of fire.

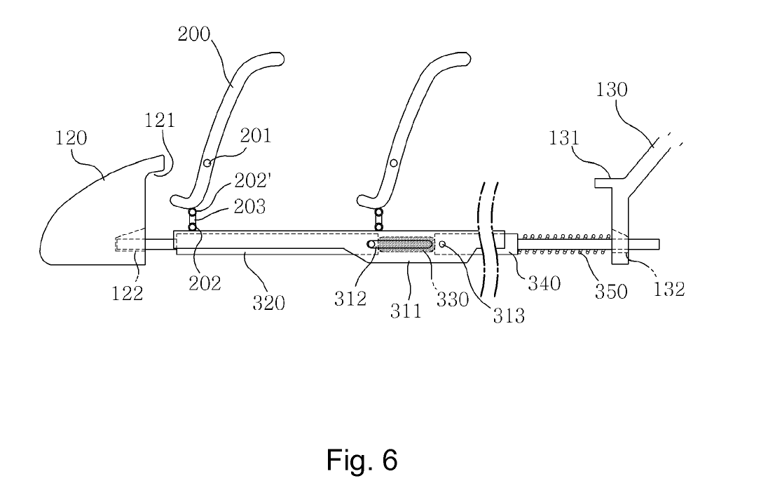

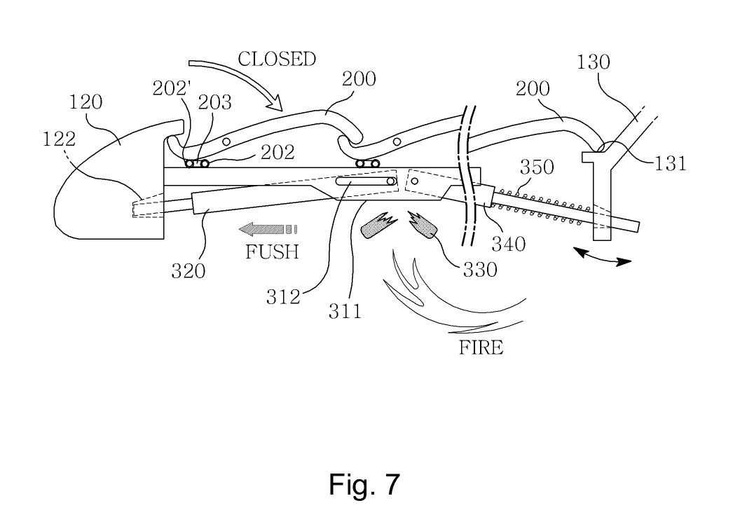

FIG. 6 is a sectional view showing the state where blades are controlled by a controller when the automatic closing louver device for fire protection according to the present invention is open in a normal state, and FIG. 7 is a sectional view showing the state where blades are controlled by a controller when the automatic closing louver device for fire protection according to the present invention is closed in a fire breaking state.

As shown in FIGS. 6 and 7, the inner upper surfaces of the front surface fixing bar insertion hole 122 and the rear surface fixing bar insertion hole 132 are inclinedly formed, so that if the flames F in fire come into contact with the fuse 330 to make the fuse 330 broken, the rear surface fixing bar 340 moves forward by means of the elastic body 350, and accordingly, the front end of the rear surface fixing bar 340 and the rear end of the front surface fixing bar 320 are lifted to move the body 310 upward.

So as to raise the body 310, in more detail, the inner upper surfaces of the front surface fixing bar insertion hole 122 and the rear surface fixing bar insertion hole 132 should be inclinedly formed. That is, the front surface fixing bar insertion hole 122 should have the space where the front end of the front surface fixing bar 320 inclinedly moves, and the rear surface fixing bar insertion hole 132 should have the space where the rear end of the rear surface fixing bar 340 inclinedly moves.

The front surface plate 120 and the rear surface plate 130 have a fixing projection 121 for fixing the lower portion of the frontmost blade 200 and a fixing projection 131 for fixing the upper portion of the rearmost blade 200, and the fixing projection 121 and the fixing projection 131 face each other. In case where the blades 200 are closed, the body 310 pushes to lift and fix the lower portions 220 of the blades 200, and the lower portion 220 of the frontmost blade 200 comes into contact with the fixing projection 121, thus allowing the frontmost blade 200 to become closed, while the upper portion 210 of the rearmost blade 200 are coming into contact with the fixing projection 131, thus allowing the rearmost blade 200 to become closed.

At this time, the body 310 pushes to lift and rigidly fix the lower portions 220 of the blades 200 by means of the elastic force of the elastic body 350, so that the blades 200 after closed are not open by means of external forces such as the wind caused by fire and the like.

Further, as shown in FIG. 7, the upper portions 210 of the blades 200 are bent backward and the lower portions 220 thereof are bent forward, thus providing the blades 200 having generally S-shaped sections, and accordingly, the upper portion 210 of the front side blade 200 comes into contact with the lower portion 220 of the rear side blade 200, thus allowing the blades 200 to be closed in case of fire.

That is, the blades 200 are formed of general plates and may have angled, oval or other sectional shapes (hereinafter, referred simply to as a plan sectional shape). However, the blades most desirably have generally S-shaped sections, as shown in FIGS. 6 and 7. In this case, even if the distance between the neighboring blades 200 is enlarged, a high lighting efficiency can be kept economically, and further, when the blades 200 are closed for fire protection, they can be closed at lower rotation angles than the blades having the plan sections. Furthermore, the neighboring blades 200 are engagedly contacted with each other, thus enhancing their fire protection efficiency. On the other hand, the blades 200 are desirably bent backward with respect to a vertical line so as to provide effective lighting and easily perform their rotation.

According to the present invention, as shown in FIG. 5, the hinge parts 202′ are upper pipes disposed on the lower ends of the blades 200, the hinge parts 202 are lower pipes disposed on the top surface of the body 310, and the hinge parts 203 are ‘ [symbol] ’-shaped fixing members connecting the upper pipes 202′ and the lower pipes 202 to each other. As shown in FIGS. 6 and 7, when the body 310 moves, the center shafts of the upper pipes 202′ and the center shafts of the lower pipes 202 become located differently from each other, thus providing spaces through which the corresponding hinge coupling is made.

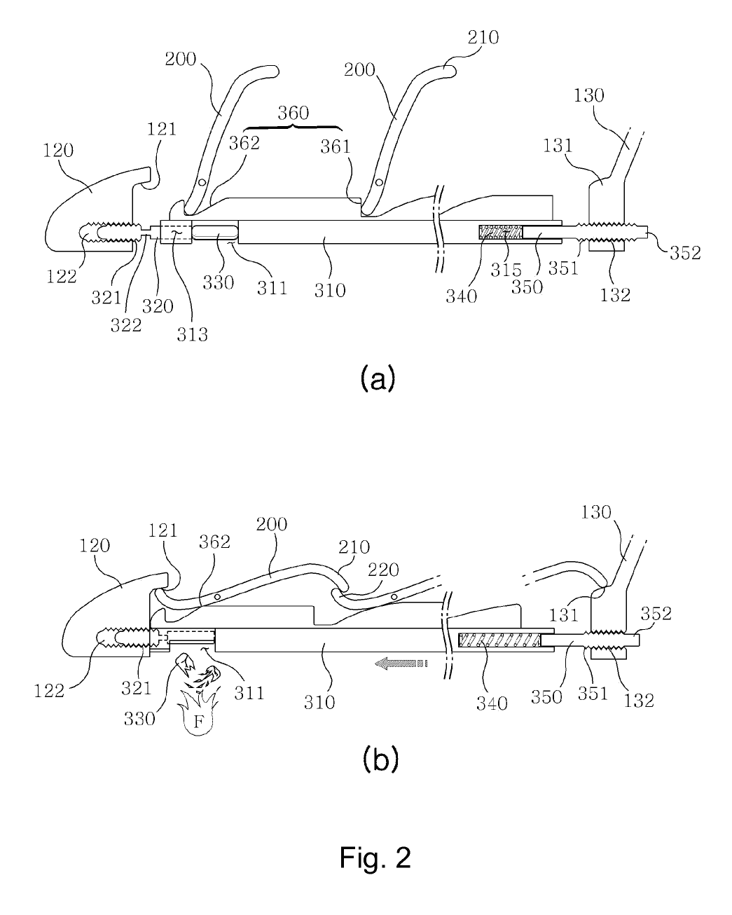

According to the conventional automatic closing louver device for fire protection as mentioned above, as shown in FIGS. 2a and 2b, the blade pusher 362 pushes to lift the lower portion 220 of the blade 200 at the time when the blade 200 is closed, so that concentrated load is intensively generated on the contacted portion between the blade pusher 362 and the lower portion 220 of the blade 200, thus undesirably making the blade 200 bent. According to the present invention, however, the out of plane load by which the length of each blade is limited occurring in the conventional louver device as shown in FIGS. 2a and 2b is removed to provide the automatic closing louver device for fire protection applicable to windows in economical and optimal manners.

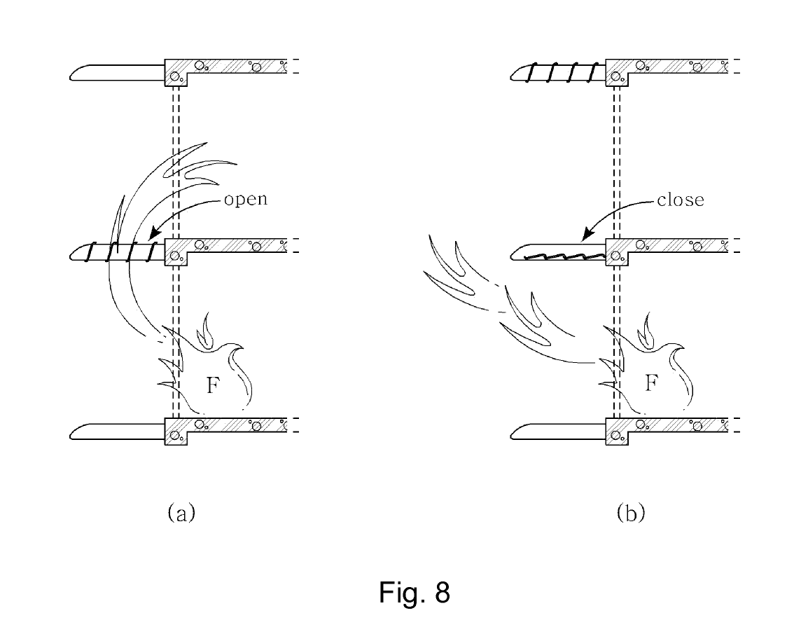

FIGS. 8a and 8b are concept views showing the state where the moving direction of the flames is controlled in accordance with the opening and closing states of the blades in a multi-floor building wherein the automatic closing louver device for fire protection according to the present invention is installed.

As shown in FIG. 8a, the blades 200 are open in a normal state, but as shown in FIG. 8b, in case of fire, the fuse 330 is broken to allow the rear surface fixing bar 340 to move forward and thus to allow the body 310 to be moved upward, so that the blades 200 become closed. Accordingly, the automatic closing louver device for fire protection according to the present invention serves as a fire wall like existing balcony and further prevents the flames F occurring on the lower floor from moving to the upper floor.

As described above, the automatic closing louver device for fire protection according to the present invention has the following advantages:

Firstly, the present invention can prevent the flames occurring on the lower floor from moving to the upper floor when a fire breaks out in an apartment having no balconies or a building having curtain walls, without using any electric energy.

Secondly, the present invention can effectively adjust lighting according to seasons, thus enhancing heat energy efficiencies and providing fresh indoor environments.

Thirdly, the present invention can need no maintenance cost because power like electric energy is not required at all, so that the structure is simple, malfunction is few, and no maintenance is needed.

Fourthly, the present invention can be installed on existing buildings, without any separate change in design.

Lastly, the present invention can remove the out of plane load by which the length of each blade is limited occurring in the conventional louver device, thus being applicable to windows in economical and optimal manners.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An automatic closing louver device for fire protection installed on an outer wall surface or on the outside of a window WD, the automatic closing louver device comprising:
a controller 300 having a front surface fixing bar 320 having protrusions 322 formed on both sides of the rear end thereof, a rear surface fixing bar 340 having protrusions 342 formed on both sides of the front end thereof, a body 310 open at the lower portion thereof and having a fuse chamber 311 formed at the inside of the lower portion thereof so as to insertedly mount a fuse 330 thereinto and slots 312 and protrusion coupling portions 313 formed on both side surfaces thereof, and an elastic body 350 adapted to provide a driving force thereto;
a plurality of plate-like blades 200 each having a blade rotating shaft 201 protrudedly formed on both ends thereof and a lower portion 220 rotatably coupled to the top portion of the body 310 by means of hinge parts 202, 202′ and 203; and
an outer frame 100 having a front surface plate 120 having a front surface fixing bar insertion hole 122 formed at the center thereof so as to insert the front end of the front surface fixing bar 320 thereinto, a rear surface plate 130 having a rear surface fixing bar insertion hole 132 formed at the center thereof so as to insert the rear end of the rear surface fixing bar 340 together with the elastic body 350 thereinto, and two side surface plates 110 each having a plurality of blade rotating shaft insertion holes 111 equally spaced apart from each other so as to insert and rotate the blade rotating shafts 201 and attached to both ends of the front surface plate 120 and the rear surface plate 130 on the front and rear ends thereof,
wherein the protrusions 322 and the protrusions 342 are coupled correspondingly to the slots 312 and the protrusion coupling portions 313, and in the state where the protrusions 322 are located at the front ends of the slots 312 and the fuse 330 is located in the fuse chamber 330 between the rear end of the front surface fixing bar 320 and the front end of the rear surface fixing bar 340, if flames F come into contact with the fuse 330 when a fire breaks out, the fuse 330 is broken and the coupled portion between the rear surface fixing bar 340 and the body 310 moves forwardly by means of the elastic body 350, so that the blades 200 are rotated and closed to form a fire protection wall.

2. The automatic closing louver device for fire protection according to claim 1, wherein the inner upper surfaces of the front surface fixing bar insertion hole 122 and the rear surface fixing bar insertion hole 132 are inclinedly formed, so that if the flames F in fire come into contact with the fuse 330 to make the fuse 330 broken, the rear surface fixing bar 340 moves forward by means of the elastic body 350 and the front end of the rear surface fixing bar 340 and the rear end of the front surface fixing bar 320 are lifted to move the body 310 upward.

3. The automatic closing louver device for fire protection according to claim 2, wherein the upper portions 210 of the blades 200 are bent backward and the lower portions 220 thereof are bent forward, thus providing the blades 200 having generally S-shaped sections, so that when the upper portion 210 of the front side blade 200 comes into contact with the lower portion 220 of the rear side blade 200, the blades 200 become closed in case of fire.

4. The automatic closing louver device for fire protection according to claim 2, wherein the hinge parts 202′ are upper pipes disposed on the lower ends of the blades 200, the hinge parts 202 are lower pipes disposed on the top surface of the body 310, and the hinge parts 203 are ‘ [symbol] ’-shaped fixing members connecting the upper pipes 202′ and the lower pipes 202 to each other, so that when the body 310 moves, the center shafts of the upper pipes 202′ and the center shafts of the lower pipes 202 are located differently from each other to provide spaces through which the corresponding hinge coupling is made.

5. The automatic closing louver device for fire protection according to claim 1, wherein the upper portions 210 of the blades 200 are bent backward and the lower portions 220 thereof are bent forward, thus providing the blades 200 having generally S-shaped sections, so that when the upper portion 210 of the front side blade 200 comes into contact with the lower portion 220 of the rear side blade 200, the blades 200 become closed in case of fire.

6. The automatic closing louver device for fire protection according to claim 1, wherein the hinge parts 202′ are upper pipes disposed on the lower ends of the blades 200, the hinge parts 202 are lower pipes disposed on the top surface of the body 310, and the hinge parts 203 are ‘ [symbol] ’-shaped fixing members connecting the upper pipes 202′ and the lower pipes 202 to each other, so that when the body 310 moves, the center shafts of the upper pipes 202′ and the center shafts of the lower pipes 202 are located differently from each other to provide spaces through which the corresponding hinge coupling is made.
